(19) United States
(12) Patent Application Publication
(10) Pub. No.: US 2020/0165693 A1
(43) Pub. Date: May 28, 2020

(54) Method for Producing a Wear-Resistant Steel Pipe, Wear-Resistant Steel Pipe, and Use of Such a Steel Pipe

(71) Applicants: ThyssenKrupp Steel Europe AG, Duisburg (DE); thyssenkrupp AG, Essen (DE)

(72) Inventors: Christoph Günster, Neukirchen-Vluyn (DE); Peter Ohse, Duisburg (DE); Jens Plha, Duesseldorf (DE); Hans-Joachim Tschersich, Dorsten (DE); Stefan Wischmann, Berlin (DE)

(21) Appl. No.: 16/611,318

(22) PCT Filed: May 9, 2018
(86) PCT No.: PCT/EP2018/062099

§ 371 Date: Nov. 6, 2019

(30) Foreign Application Priority Data
May 16, 2017 (DE) 10 2017 110 631.6

(51) Int. Cl. C21D 9/14; C21D 9/50; B23K 13/02; C22C 38/04; C21D 9/08; B21C 37/08; C22C 38/14; C22C 38/32; C22C 38/12; C22C 38/02; C21D 8/10; C22C 38/08; B23K 101/06

(52) U.S. Cl. CPC C21D 9/14; C21D 9/505; B23K 13/025; C22C 38/04; C21D 9/085; B21C 37/08; B23K 2101/06; C22C 38/32; C22C 38/12; C22C 38/02; C21D 8/105; C22C 38/08; C22C 38/14

(57) ABSTRACT

A process for the industrial production of wear-resistant steel pipes having an optimized life. The process includes providing a wear-resistant, hardenable steel sheet in an unhardened or tempered state, shaping the steel sheet into a tubular preform in which two longitudinal edges of the steel sheet are positioned opposite one another with a welding gap extending between the two edges, welding the longitudinal edges by forming a welded seam which closes the welding gap, thereby forming a steel pipe, and heat treating the steel pipe. The heat treatment of the steel pipe includes heating the steel pipe at an average heating rate of 5-400 K/s to a hold temperature which is ≥ the Ac3 temperature of the steel and ≥1100° C., holding the steel pipe at the hold temperature for 1-120 s, and cooling the steel pipe at an average cooling rate of 10-600 K/s to room temperature.

The invention relates to a process for producing a wear-resistant steel pipe.

The invention likewise relates to a highly wear-resistant steel pipe and the advantageous use thereof.

The brochure “Production processes for steel pipes (Herstellverfahren für Stahlrohre)” (see http://www.smrw.de/Deutsch/messen-und-medien/publikationen/publikationen.html) written by Dr.-Ing. Karl-Heinz Brensing et al. and published by Mannesmannrohren-Werke AG contains an overview of the conventional processes for producing steel pipes. According to this publication, welded steel pipes having diameters of from 6 to 2500 mm and wall thicknesses of 0.5-40 mm are usually produced with a longitudinal seam or with a helical seam. As starting material, use is generally made of rolled sheets which, depending on the production process, pipe dimensions and intended use, can consist of hot-rolled or cold-rolled strip steel, hot-rolled wide strip or heavy plate. The physical properties and the surface quality required of the pipe are in many cases already present in the rolled flat product but can if required also be set by a heat treatment following shaping of the pipe or by cold strengthening of the pipe. Here, forming of the respective sheet material into the pipe can be carried out hot or cold in continuous pipe forming or in individual pipe forming. In continuous pipe forming, uncoiled strip material is taken off from a reservoir while a fresh strip is welded on at the end of the uncoiled strip. The “continuous” strip produced in this way is shaped in a continuous process into the pipe. In the case of the individual pipe manufacture, pipe shaping and welding process are, in contrast, not carried out in multiple lengths but in individual pipe lengths. In the shaping operation, the sheet material is shaped into a tubular preform in which the longitudinal edges of the sheet are opposite one another and between them bound a welding gap which is closed by use of conventional welding processes which have been known for a long time for this purpose.

One process which allows, in individual pipe manufacture, pipes to be formed from sheets having a high thickness of, for example, at least 15 mm (“heavy plates”) is the “U-O process” described in chapter 4.2.3 of the brochure “Production processes for steel pipes (Herstellverfahren für Stahlrohre)”. In this process, the respective sheet is in a first step shaped into a preform having a U-shaped cross section, from which a preform having an O-shaped cross section is then formed in a second step, with the longitudinal edges of the cut-to-size sheet bounding a join slit extending over the length of the preform. The preform obtained in this way is in the technical field also referred to as “round slit pipe”.

Helical pipe production is described in chapter 4.2.4 of the brochure “Production processes for steel pipes (Herstellverfahren für Stahlrohre)”. This production route starts out from a cut-to-size sheet which is strip-like and has a width smaller than the circumferential length of the pipe to be produced, while its length is significantly greater than the length of the pipe to be produced. The sheet of this size is wound in a spiral fashion into a hollow body which has a circular cross section and in which the join bounded by the longitudinal edges of the cut-to-size sheet which are opposite one another accordingly runs in a helical fashion around the hollow body. Helical pipe production is particularly suitable for continuous “never ending” pipe production.

The demand for large pipes for the transport of mechanically wearing media which bring about abrasive wear is increasing steadily. These media, for example alluvial sands, are transported through pipelines over long distances in order to progress land recovery. Here, the hard, fast-flowing sand grains come into contact with the inside of the pipeline and considerable wear arises. The abrasive stress on the pipes occurring in this way leads to short lives and high capital and maintenance costs for the pipeline systems.

Other uses of large pipes of the type in question here are, for example, the transport of oil sands or other fluids which comprise particulate, hard constituents and accordingly cause high-material-removing stress on the conduit pipes.

Pipes intended for the abovementioned purposes are conventionally produced in the thickness range up to 25 mm from hot strip grades having strengths of up to about 350 N/mm² by helical seam pipe welding by means of underpowder welding methods (UP welding). In the thickness range above 25 mm, production is carried out from heavy plates which in the individual process are shaped by means of U/O forming into pipes and welded with a longitudinal seam.

One approach for improving the life of steel pipes which in use are subject to abrasive stress was to use known, highly wear-resistant steels. Such steels acquire their wear resistance from a specific alloy composition and a heat treatment matched thereto. An example of such a steel is the steel alloy known under the name “XAR 450”, which contains (in % by weight) less than 0.22% of C, less than 1.5% of Mn, less than 0.8% of Si, less than 1.3% of Cr and less than 0.5% of Mo in addition to iron and unavoidable impurities. At a maximum sheet thickness of 100 mm, this steel has, in the quenched state, a hardness HB of 410-480 (see brochure “Steel XAR”, Oct. 2016 edition, catalog No. 0606, broschueren.steel@thyssenkrupp.com).

Another steel suitable for producing highly wear-resistant pipes is known from DE 34 14 477 C2. This steel consists (in % by weight) of 0.7-1% of Mn, 0.7-2.2% of Cr, 0.3-0.6% of Mo, 0.5-2.2% of Ni, not more than 0.45% of C and iron and usual admixtures as the remainder and is said to make it possible to produce weldable pipes which are subject to high abrasive stresses, for example in an oil field or other comparable uses. The mechanical properties of the sheets consisting of this steel are set in a heat treatment process in which a steel sheet made of this steel is heated to an austenitizing temperature of about 860° C., subsequently quenched from this temperature to a temperature of 90° C. and then tempered at a temperature of 350-450° C. After slit pipes have been formed from the steel sheets which have been tempered in this way, these slit pipes are then to be heated locally to a temperature of about 250° C. and then provided with a multilayer welded seam. The first welding layer is to be applied at a temperature of about 250° C. and the subsequent layer at a temperature of 200° C. It is said that a thermal after-treatment of the welded seam can be saved in this way.

U.S. Pat. No. 5,397,654 A describes another concept for a highly wear-resistant, welded steel pipe. The steel pipe is produced from a steel which consists (in % by weight) of 0.05-0.2% of C, 0.5-2% of Si, 0.5-2.5% of Mn, 0.02-2% of Al, the remainder iron and unavoidable impurities and can contain, in each case optionally, 0.05-1% of Cu, 0.05-2% of Ni, 0.05-2% of Cr, 0.05-1% of Mo, 0.005-0.1% of Nb, 0.005-0.1% of V, 0.005-0.1% of Ti or 0.0003-0.002% of B. The steel pipe has a Vickers hardness HV of 200-350 and is produced by shaping a sheet consisting of the steel by hotforming into the pipe and subsequently welding it along a longitudinal seam. Before or after this welding, the pipe is subjected to a heat treatment. In this heat treatment, the pipe is heated to a temperature which is between the AC3 temperature and the AC1 temperature, and is then quenched by means of water.

Regardless of the way in which they are produced, a fundamental problem associated with welded pipes made of hardened metal sheets is that the introduction of heat into the so-called “heat influence zone”, which unavoidably occurs when welding the pipes, leads to local tempering, as a result of which the hardness of the pipe steel decreases greatly in the region around the welded seam compared to the hardness outside the heat influence zone. This softening results in a local decrease in the wear resistance, which reduces the life of the overall component. Although the welded product also generally has a relatively low hardness and thus wear resistance, this is in practice compensated for by the so-called “seam protrusion”, i.e. a relatively great accumulation of welding material on the inside of the tube in the region of the welded seam. The decreased hardness of the steel in the heat influence zone, on the other hand, leads to local increased removal of material which shows up as a highly structured surface (alternating sequence of hills and valleys formed on the inside of the pipe in the region of the seam). The flow of the medium conveyed along the inside of the pipe is adversely affected thereby, which in turn leads to increased local wear, known as scouring, in these zones.

A further problem in the processing of wear-resistant steels results from these steels being able to be deformed only with difficulty when they have been processed to form a sheet and hardened. The setting of a high hardness to achieve the wear resistance is generally associated with a high yield point, so that wear-resistant steels in the hardened or tempered state as supplied are generally not suitable for forming into a pipe.

In the light of the above-described prior art, it is the object of the invention to develop an industrially usable process for producing wear-resistant steel pipes having an optimized life.

In addition, a steel pipe having optimized wear resistance should be provided.

Finally, advantageous uses of such a steel pipe should be indicated.

In respect of the process, the invention has achieved this object in that at least the working steps indicated in claim 1 should be completed in the production of highly wear-resistant steel pipes.

The features of a steel pipe which achieves the abovementioned object are specified in claim 13.

Industrially relevant uses of the pipe according to the invention are indicated in claim 15.

Advantageous embodiments of the invention are indicated in the dependent claims and will be explained in detail below, as will the general inventive concept.

A process according to the invention for producing a steel pipe accordingly comprises the following working steps:
a) provision of a steel sheet which consists of a wear-resistant, hardenable steel, with the steel sheet being provided in an unhardened or tempered state;
b) shaping of the steel sheet into a tubular preform in which two longitudinal edges of the steel sheet are positioned opposite one another and bound a welding gap between them;
c) welding of the longitudinal edges which are arranged opposite one another and bound the welding gap to form a welded seam which closes the welding gap;
d) heat treatment of the steel pipe obtained after the working step c), wherein the heat treatment comprises the following working steps:
d.1) heating of the steel pipe at an average heating rate of 5-400 K/s to a hold temperature which is at least equal to the Ac3 temperature of the steel and is not more than 1100° C.;
d.2) holding of the steel pipe at the hold temperature for 1-120 s and
d.3) cooling of the steel pipe at an average cooling rate of 10-600 K/s to room temperature.

The steel sheet provided in working step a) can consist of wear-resistant and hardenable steels which are known per se and have been described above. However, steel sheets composed of a steel which consists (in % by weight) of
C: 0.2-0.4%,
Si: 0.1-0.9%,
Mn: 1.0-2.0%,
S: up to 0.03%,
P: up to 0.04%,
and in each case optionally an element or a plurality of elements selected from the group “Cr, Mo, Ni, Ti, B”, with the proviso
   Cr: 0.1-2.0%,
   Mo: 0.3-0.7%,
   Ti: up to 0.04%,
   Ni: up to 2.0%,
   B: up to 0.004%,
and iron and unavoidable impurities as the remainder have been found to be particularly suitable for the purposes of the invention.

C contents of 0.2-0.4% by weight ensure the hardenability in the steel used according to the invention.

The Si content of at least 0.1% by weight in the steel processed according to the invention brings about satisfactory deoxidation and hardenability of the steel. Restricting the Si content to not more than 0.9% by weight at the same time ensures satisfactory red scale resistance and toughness. The steel processed according to the invention can be optimized in respect to these properties by the Si content being not more than 0.4% by weight. On the other hand, if the Si content is increased to at least 0.6% by weight, an optimized hardenability is established.

Mn contents of 1.0-2.0% by weight in the steel used according to the invention contribute to good hardenability and ductility. In order to be able to utilize this effect particularly reliably, it can be advantageous to increase the Mn content to at least 1.1% by weight. Restricting the Mn content to not more than 1.5% by weight can decrease the tendency for banded segregations.

S and P are undesirable accompanying elements in the steel according to the invention. In order to avoid their interfering influence reliably, the S content of the steel is restricted to not more than 0.03% by weight and the P content of the steel is restricted to not more than 0.04%.

Optional addition of Cr in contents of 0.1-2.0% by weight makes it possible to achieve an increased wear resistance in the steel processed according to the invention. Here, it can be advantageous to increase the Cr content to at least 1.0% by weight in order to achieve improved corrosion resistance. On the other hand, if the Cr content is restricted to not more than 0.5% by weight, better elongation values tend to be able to be achieved.

A likewise optional addition of 0.3-0.7% by weight of Mo makes it possible to bring about grain refinement and to reduce the critical cooling rate.

Ti can be added, likewise optionally, to the steel according to the invention in order to bind nitrogen and thus improve the hardenability-promoting action of boron. Here, Ti contents of at least 0.025% by weight have been found to be particularly advantageous in this respect.

Optionally present contents of Ni of up to 2.0% can contribute to an increase in the yield strength and tensile strength.

Furthermore, B can optionally be added to the steel according to the invention in contents of up to 0.004% in order to improve the hardenability. B contents of at least 0.0008% by weight have been found to be particularly advantageous for this purpose.

The steel sheets provided according to the invention can be produced in a conventional way by casting an appropriately alloyed steel melt into an intermediate (slab, thin slab or cast strip) and, after the usual pretreatments have been carried out, hot rolling this intermediate into a hot-rolled flat product. The flat product can be a steel strip or a steel sheet having a relatively great thickness, known as “heavy plate”.

For the purposes of the invention, it is important that the steel sheet provided in working step a) of the process of the invention is in the unhardened or tempered state. Steel sheets which are in this state can be preformed significantly more simply and to a greater degree than the hardened steel sheets which are usually shaped into pipes in conventional processes.

The forming of the steel sheet carried out in working step b) into the preform can accordingly be carried out comparatively easily. The preform is, especially in the case of a steel pipe produced by individual manufacture, typically a slit pipe in which the welding gap extends over the length of the pipe parallel to the longitudinal axis thereof, or, especially in the case of continuous production, is a helical winding wound uniformly around the longitudinal axis of the pipe, in the case of which the welding gap runs circumferentially in the manner of a helix with an optimally uniform pitch around the hollow space enclosed by the helical winding.

The shaping of the pipe itself can be carried out in any of the known ways described, for example, in the brochure mentioned above. Thus, the working step b) can if necessary be completed in two or more substeps. This can be useful particularly in the processing of particularly thick sheets having a thickness of, for example, more than 40 mm.

For individual manufacture, the steel sheet can, in working step a), be provided as cut-to-size sheet whose width corresponds to the circumferential length and whose length corresponds to the length of the steel pipe to be produced. Such a steel sheet can then be shaped in the U-O process into the pipe by forming a preform having a U-shaped cross section from the steel sheet in a first working substep and forming a preform having a circular or ellipsoidal cross section from the U-shaped preform in a second working substep.

As an alternative, it is of course likewise conceivable for the steel sheet to be, especially for a continuous production process, provided in working step a) as a strip section having a width which is smaller than the circumferential length of the steel pipe to be produced and having a length which is greater than the length of the steel pipe to be produced and for this steel sheet then to be wound following a screw line into the tubular preform in working step b).

If necessary, shaping of the steel sheet in working step b) into the preform can be carried out, at least in one working substep, as hotforming. This can be advantageous in order to limit the forming forces required for shaping the steel sheet.

In respect of working step b), the invention proceeds from the recognition that the forming in the production of helical-seam-welded or longitudinal-seam-welded large pipes is not determined by the forming capability of the materials. Thus, taking into account the large pipe diameter and wall thicknesses, the elongation required for shaping of the pipes is significantly less than 3%. The limiting factor in carrying out the forming process is instead the forming force required, which is determined by the geometry (radius, wall thickness) and the material properties (alloy, microstructure and yield strength) of the steel sheet from which the steel pipe is to be made.

Thus, the invention allows steel sheets having a thickness of at least 15 mm, in particular at least 25 mm or even at least 40 mm, to be shaped without problems into steel pipes.

Here, the pipes according to the invention can have diameters of more than 450 mm without problems.

The advantage of the invention here is minimization of the forming force required for shaping the pipe even when using highly wear-resistant alloys, since the setting of the microstructure occurs in the final working step d).

This working step d) can also be referred to as “homogenizing heat treatment” because a uniform microstructure in the steel of at least the steel sheet from which the pipe is formed is obtained by means of this heat treatment, in particular also in the zone which is influenced by the introduction of heat during welding. A high microstructural homogeneity over the entire component including the welding seam can be achieved by the alloy composition of the welding material introduced to close the welding gap being matched to the composition of the steel of the steel sheet from which the pipe is formed, so that, from the point of view of the alloy too, a more homogeneous state of the component is achieved and an overall uniform behavior of the materials coming together in the welding seam is ensured during the heat treatment.

The invention thus makes it possible to avoid softening of the steel material in the heat influence zone. Instead, there are at most only comparatively small hardness differences between the welding seam and the adjacent regions of the steel pipe and also the other regions of the steel pipe in the case of a steel pipe produced according to the invention.

Associated with this effect, the wear resistance even in the region of the steel pipe adjoining the welded seam is increased, so that an overall increased life of a steel pipe produced according to the invention is ensured. At the same time, the outlay required for shaping the pipe is minimized in the procedure according to the invention. This allows highly wear-resistant steels which would be deformable only with great difficulty, if at all, in a conventional procedure to be used for the purposes of the invention.

A steel pipe according to the invention having a diameter of at least 200 mm, a wall thickness of at least 15 mm and a welded seam extending linearly in the longitudinal direction of the steel pipe or running in a helical fashion around the longitudinal axis of the steel pipe is accordingly characterized
in that it is formed from a steel sheet which consists of
   C: 0.2-0.4%,
   Si: 0.1-0.9%,
   Mn: 1.0-2.0%,
   S: up to 0.03%,
   P: up to 0.04%,
   and, in each case optionally, an element or a plurality of elements selected from the group “Cr, Mo, Ni, Ti, B”, with the proviso
      Cr: 0.1-2.0%,
      Mo: 0.3-0.7%,
      Ti: up to 0.04%,
      Ni: up to 2.0%,
      B: up to 0.004%,
   and iron and unavoidable impurities as the remainder and
in that the difference between the hardness of the heat influence zone adjoining the welded seam of the steel pipe and the hardness of the steel sheet outside the heat influence zone is not more than 30 HV10.

When mention is made here of the “difference” between the hardness of the heat influence zone surrounding the welded seam of the steel pipe and the hardness of the steel sheet outside the heat influence zone, what is meant is the absolute value of the difference between the hardness values determined for the heat influence zone and the region located outside the heat influence zone.

The advantage arising therefrom, namely the absolute hardness difference between base material and the heat influence zone not being more than 30 HV10, is the fact that the wear process into the depth of the material in the region directly adjoining the welded seam is increased to the level of the base material and thus occurs uniformly, which enables the life of the component to be fully exploited.

The hardness of the steel sheets used according to the invention before the heat treatment according to the invention is typically 180-210 HV10 and after the heat treatment according to the invention is typically 450-550 HV10.

The Vickers hardness values indicated here are determined in a manner known per se in accordance with DIN EN ISO 6507-1:2006-03.

A steel pipe according to the invention can optimally be produced by employing a process according to the invention.

A steel pipe having the nature according to the invention has an optimal resistance to abrasive wear, which is reflected in a significantly reduced removal of material per unit time and thus an increased life of the component.

The welding in working step c) can be carried out in any way which is known from the prior art and is suitable. Welding by the underpowder welding method, which is tried and tested in industrial use and has a high fusion performance and good economics has been found to be particularly useful here.

The required hardness and strength is gained by the steel of a steel pipe having the nature of and produced according to the invention as a result of the heat treatment completed in working step d).

In this heat treatment, the pipe is firstly heated at a sufficient heating rate to a hold temperature at which it is held until the pipe has been heated all through, i.e. as a whole is at the hold temperature. The lower limit of the average heating rate is selected so that the risk of distortion of the pipe as a result of heating is avoided and at the same time an optimal heating result from economic-energy points of view is also achieved. At the same time, the average heating rate is restricted to not more than 400 K/s because in this way satisfactory heating all through due to heat conduction is achieved even when the heat input, for example in an inductive or conductive heating operation, occurs in a locally restricted region.

The hold temperature and the hold time are selected so that firstly reliable heating all through of a steel pipe produced according to the invention, even taking into account the large wall thickness, is ensured and secondly an almost complete austenitic microstructure, which is the prerequisite for achieving a maximum hardness, is present in the steel. At the same time, the hold temperature is restricted to not more than 1100° C. in order to counter undesirable enlargement of the grain size. Likewise, the hold time is restricted to 120 s in order to avoid coarse grain and excessive scale formation.

After the hold time, the pipe is quenched to room temperature, with the average cooling rate being at least 10 K/s, in order to attain the required hardness. The average cooling rate is not more than 600 K/s because a greater cooling rate is difficult to realize in industry and no increase in the maximum hardness is to be expected at cooling rates above 600 K/s.

The heating parameters in the working step d) are, according to the invention, selected so that heating can be brought about by means of an inductively operating heating device which is known per se for this purpose. In inductive heating, the pipe to be heated is conveyed continuously through one or more ring-shaped inductors and thus subjected to an alternating electromagnetic field. In this way, eddy currents are generated without contact in the steel material of the pipe subjected to the alternating field and heat arises.

Even if it is in principle possible to introduce a pipe which has been shaped and welded in the working steps b) and c) of the process according to the invention into a furnace in order to bring it to the hold temperature and maintain it at this temperature, a particularly advantageous variant of the invention provides for the heating to the hold temperature and the holding at the hold temperature to be carried out by means of inductive heating, with such inductive heating typically being carried out in continuous passage and the pipe in this case according to the invention thus not being heated in one piece to the hold temperature, held there and cooled but instead the heat treatment as per working step d) being carried out successively, for example starting from one end of the steel pipe, in a continuous process over its length.

As an alternative to inductive heating, conductive heating carried out with continuous passage in a manner corresponding to inductive heating is also conceivable, in which case the section of the pipe to be heated itself forms part of the electrical circuit provided for the introduction of heat.

Steel pipes produced according to the invention or having the nature according to the invention are particularly suitable for the transport of bulk materials, fluids or mixtures thereof flowing through them because of their maximal wear resistance.

Here, pipes produced according to the invention or having the nature according to the invention can be used for land recovery, in, for example, offshore dredges used for washing up sand, for waste disposal, in or on extruders, in the transport of snow or ice transportation, in bulk material transport in the chemical industry or the food industry (e.g. for the transport of cereal), in the field of power stations or cement works, in the utilization of water power, in ore recovery or the transport of ores and comparable rock applications, in the transport of oil sand, in the mining industry, in fracking, in all industrial applications in which fluids loaded with particles are conveyed, in concrete pumps and in general coal mining.

The invention will be illustrated below with the aid of a working example. In the figures:

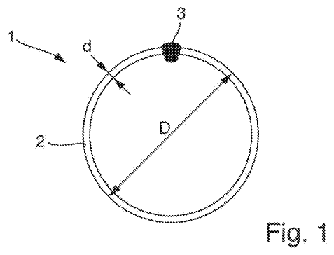

FIG. 1 shows a frontal view of a longitudinal-seam-welded steel pipe produced according to the invention;

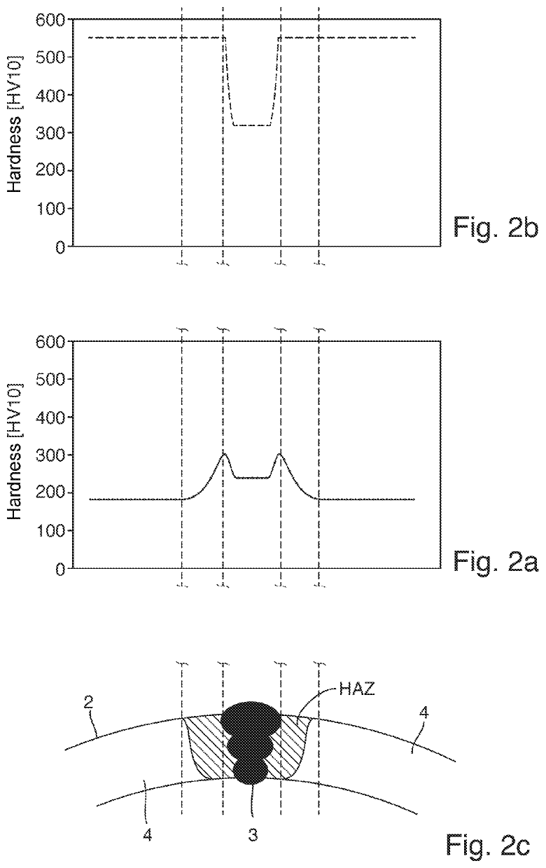

FIG. 2a shows the course of the hardness in the region of the longitudinal welded seam of the steel pipe of FIG. 1 after welding and before the heat treatment;

FIG. 2b shows the course of the hardness in the region of the longitudinal welded seam of the steel pipe of FIG. 1 after the heat treatment;

FIG. 2c shows a section of FIG. 1.

The steel pipe 1 having a circular cross section and an external diameter D of 800 mm which is shown in FIG. 1 has been produced from a cut-to-size sheet having a thickness d of 20 mm, the width of which corresponds to the circumferential length of the steel pipe 1 and the length of which corresponds to the length of the steel pipe 1 to be produced.

The steel sheet 2 consisted of a steel having the composition shown in Table 1.

TABLE 1
Figures in % by weight: remainder iron and unavoidable impurities

| C | Si | Mn | P | S | Cr | B | Ti | Mo | Ni |
|---|---|---|---|---|---|---|---|---|---|
| 0.3 | 0.25 | 1.3 | 0.02 | 0.01 | 0.3 | 0.0025 | 0.032 | 0.05 | 0.05 |

The steel sheet 2 which has this composition and is provided in the unhardened delivery state has been formed in a manner known per se in individual manufacture firstly into a preform configured as a slit pipe, in which preform the longitudinal edges of the steel sheet 2 were arranged opposite one another and between them bound a welding gap extending over the length of the steel pipe 1.

The preform was subsequently welded by the welding gap being closed in a manner known per se by means of underpowder welding method to form a longitudinal welded seam 3 extending over the length of the steel pipe 1. As a result of the welding and the introduction of heat associated therewith, hardening effects have occurred in the heat influence zones HAZ extending over the longitudinal edge regions of the steel sheet 2 which laterally adjoin the welded seam 3, due to which hardening effects the hardness of the steel sheet 2 in the heat influence zones HAZ was higher than in the regions 4 of the steel sheet 2 which were located outside these zones HAZ and were uninfluenced by the welding heat introduced (FIG. 2a).

After welding, the steel pipe 1 was heated by means of inductive heating at a heating rate of 9 K/s to a hold temperature of 930° C. at which it was held for 20 seconds in order to achieve reliable heating all through.

After the hold time, the steel pipe 1 was cooled at a cooling rate of 30 K/s to room temperature (25° C.).

The hardness HV10 of the thus heat-treated steel pipe 1 was measured in accordance with DIN EN ISO 6507-1:2006-03 in agreement with the procedure set down in DIN EN ISO 3183:2012 in the heat influence zones HAZ and the regions 4 of the steel pipe located outside. The hardness indentations were arranged 1.5 mm below the surface. The hardness profile determined in this way is depicted in FIG. 2b. It is found that the absolute value of the difference between the hardness in the outer regions 4 and the hardness in the heat influence zones HAZ was not more than 20 HV10.

1.-15. (canceled)

16. A steel pipe having a diameter of at least 200 mm, a wall thickness of at least 15 mm and having a welded seam which extends linearly in the longitudinal direction of the steel pipe or runs helically around the longitudinal axis of the steel pipe, wherein the steel pipe is formed from a steel sheet comprising (in % by weight):
C: 0.2-0.4%,
Si: 0.6-0.9%,
Mn: 1.0-2.0%
optionally, one element or a plurality of elements selected from the group consisting of Cr, Mo, Ti, Ni, B, where
Cr: 1.0-2.0%,
Ti: up to 0.04%,
Mo: 0.3-0.7%,
Ni: up to 2.0%, and
B: up to 0.004%,
and iron and unavoidable impurities as the remainder
and
the difference between a hardness of a heat affected zone (HAZ) adjoining the welded seam of the steel pipe and a hardness of the steel sheet outside of the heat affected zone is not more than 30 HV10.

17. The steel pipe according to claim 16, wherein the wall thickness is at least 40 mm.

18. A process for producing a steel pipe according to claim 16, comprising the following working steps:
a) providing an at least 15 mm thick steel sheet which comprises a wear-resistant, hardenable steel, wherein the steel sheet is provided in an unhardened or tempered state and wherein the steel sheet comprises (in % by weight):
C: 0.2-0.4%,
Si: 0.1-0.9%,
Mn: 1.0-2.0%,
S: up to 0.03%,
P: up to 0.04%,
optionally, one element or a plurality of elements selected from the group consisting of Cr, Mo, Ni, Ti, B, wherein
Cr: 0.1-2.0%,
Mo: 0.3-0.7%,
Ti: up to 0.04%,
Ni: up to 2.0%, and
B: up to 0.004%,
and iron and unavoidable impurities as the remainder;
b) shaping of the steel sheet into a tubular preform in which two longitudinal edges of the steel sheet are positioned opposite one another with a welding gap extending between the two edges;
c) welding of the longitudinal edges which are arranged opposite one another by forming a welded seam which closes the welding gap, thereby forming a steel pipe;
d) heat treating the steel pipe, wherein the heat treatment comprises the following working steps:
d.1) heating the steel pipe at an average heating rate of 5-400 K/s to a hold temperature which is at least equal to the Ac3 temperature of the steel and is not more than 1100° C.;
d.2) holding the steel pipe at the hold temperature for 1-120 s;
and
d.3) cooling the steel pipe at an average cooling rate of 10-600 K/s to room temperature.

19. The process according to claim 18, wherein, in working step b), the steel pipe is formed in at least two working substeps.

20. The process according to claim 18, wherein the steel sheet is provided in working step a) as a cut-to-size sheet with a width that corresponds to a circumferential length of the steel pipe to be produced and a length that corresponds to a length of the steel pipe to be produced.

21. The process according to claim 20, wherein a preform having a U-shaped cross section is formed from the steel sheet in the first working substep and a preform having a circular or ellipsoidal cross section is formed from the U-shaped preform in the second working substep.

22. The process according to claim 18, wherein the steel sheet is provided in working step a) as strip section having a width which is smaller than a circumferential length of the steel pipe to be produced and having a length which is greater than a length of the steel pipe to be produced and wherein the steel sheet is wound following a screw line in working step b) into the tubular preform.

23. The process according to claim 18, wherein the shaping of the steel sheet in the working step b) into the preform is carried out as hotforming in at least one working substep.

24. The process according to claim 18, wherein, in working substep d.1), the steel pipe is heated by inductive heating.

25. The process according to claim 18, wherein, in working substep d.1), the steel pipe is heated by conductive heating

26. The process according to claim 18, wherein in working substep d.1), heating is carried out with continuous passage.

27. The process according to claim 18, wherein, in working substep d.1), the steel pipe is introduced into a furnace and heated to the hold temperature in.

28. A transportation passage for bulk material, fluids, or mixtures thereof comprising a steel pipe according to claim 16.
